(19) United States
(12) Patent Application Publication
(10) Pub. No.: US 2010/0162859 A1
(43) Pub. Date: Jul. 1, 2010

(54) HAND TOOL FOR ASSEMBLING AND DISASSEMBLING WORKPIECES

(76) Inventor: Kyle Roppolo, Long View, TX (US)

Correspondence Address: JAY M. SCHLOFF, 6960 Orchard Lake Road, Suite 315, West Bloomfield, MI, 48322, US

(21) Appl. No.: 12/537,730

(22) Filed: Aug. 7, 2009

Related U.S. Application Data
(60) Provisional application No. 61/087,333, filed on Aug. 8, 2008.

(51) Int. Cl. B25B 7/04; B25B 7/14

(52) U.S. Cl. 81/321; 81/387; 81/426.5

(57) ABSTRACT

A hand tool for assembling and disassembling a plurality of workpieces is provided. The hand tool comprises a pair of handle members, a pair of intermediate members pivotally coupled to the pair of handle members, a pair of jaw members pivotally coupled to the pair of intermediate members, a spring member mounted between the pair of handle members, and a locking mechanism configured on the pair of handle members. Accordingly, upon applying a grasping force to the pair of handle members, the spring member is compressed and the pair of intermediate members converge towards each other thereby allowing the pair of jaw members to grasp the at least a portion of the workpiece therebetween for assembling and disassembling the plurality of workpieces. Further, upon grasping the at least a portion of the workpiece, the pair of handle members are held in a locked state by the locking mechanism.

### CROSS REFERENCE TO RELATED APPLICATIONS

The present disclosure claims priority under 35 United States Code, Section 119 on the U.S. Provisional Patent Application numbered 61/087,333 filed on Aug. 8, 2008, the disclosure of which is incorporated by reference.

### FIELD OF THE DISCLOSURE

The present disclosure generally relates to hand tools, and, more particularly to a hand tool for assembling and disassembling a plurality of workpieces, such as duct pieces.

### BACKGROUND OF THE DISCLOSURE

Typically, duct systems are used for transporting air, fumes, dust, and heat from one area to another area in a commercial or residential building structure. Mostly, the duct systems include a plurality of workpieces, such as duct pieces, assembled together to form a long duct, used for transporting air, heat, and the like, from the one area to another area. The workpieces of a duct system are generally fabricated from sheet metal with the help of tools. For example, while fabricating a small workpiece two pieces of sheet are assembled along the edges thereof with the help of a hammer. In case of bigger workpieces, four pieces of sheet are assembled along the edges thereof. Further, for the purpose of maintenance or in case of any error, the assembled workpieces may be disassembled from each other with the help of conventional hand tools, such as hammers, screwdrivers, and pliers.

Typically, such hand tools require an individual to use both hands for operating the hand tool while assembling or dissembling the workpieces. For example, while disassembling the workpieces, such as duct pieces, the hand tool needs to be opened and closed repeatedly. Once closed, the opening of the hand tool may be achieved by manually separating handles of the hand tool. Such manual separation necessitates an individual to utilize both hands thereof. The use of both hands for separation the handles of the hand tool restricts the use of the hands of the individual for performing other tasks associated with the disassembling of the workpieces. Accordingly, the use of conventional hand tools may be time consuming for disassembling the workpieces, such as duct pieces.

Moreover, assembling the workpieces together using the conventional hand tool necessitates requirement of an additional support for gripping the workpieces. Specifically, for assembling two workpieces, edges of the two workpieces are brought together so as to overlap with each other. The overlapped edges are held close to each other by utilizing a conventional hand tool. Thereafter, the overlapped edges are permanently coupled together by sliding a connector, such as a cleat, throughout the length of the overlapped edges. However, utilizing the conventional hand tool for assembling the workpieces has a few disadvantages. Specifically, for holding the overlapped edges together, the individual has to hold the pair of handles of the hand tool closed to each other, thereby allowing the coupling of the overlapping edges with the connector. The need of holding the handles of the hand tool for gripping the workpieces together restricts the use of the hands of the individual for sliding the connector. This necessitates the requirement of another individual for holding the pair of handles of the hand tool while the individual slides the connector throughout the length of the overlapped edges of the workpieces.

Moreover, the conventional hand tools may pose limitations while being utilized in confined spaces. For example, such hand tools may not be able to be utilized for assembling, disassembling or maintenance of the workpieces mounted in proximity to a wall or a pipe.

Accordingly, there exists a need for a hand tool that is capable of being used for assembling and disassembling workpieces, such as duct pieces, in a convenient and time efficient manner. Further, there exists a need for a hand tool capable of being used in a confined space for assembling and disassembling of workpieces.

### SUMMARY OF THE DISCLOSURE

In view of the forgoing disadvantages inherent in the prior-art, the general purpose of the present disclosure is to provide a hand tool for assembling and disassembling workpieces, to include all advantages of the prior art, and to overcome the drawbacks inherent in the prior art.

Accordingly, an object of the present disclosure is to provide a hand tool that may be operated by using a single hand of an individual while assembling or disassembling workpieces, such as duct pieces.

Another object of the present disclosure is to provide a hand tool capable of gripping and holding workpieces together without a support of an individual's hand.

Yet another object of the present disclosure is to provide a hand tool capable of being used in a confined space for assembling and disassembling the workpieces.

To achieve the above objects, the present disclosure provides a hand tool for assembling and disassembling a plurality of workpieces. The hand tool comprises a pair of handle members, a pair of intermediate members, a pair of jaw members, a spring member, and a locking mechanism. The each handle member of the pair of handle members comprises a top end portion, a bottom end portion, and a coupling portion extending sideways from the top end portion. The pair of handle members is pivotally coupled to each other at respective coupling portions. Each intermediate member of the pair of intermediate members comprises a lower end portion, an upper end portion, and an attaching portion extending between the upper end portion and the lower end portion. The lower end portion of each of the pair of intermediate members is pivotally coupled to the top end portion of respective handle member of the pair of handle members. Further, the pair of intermediate members is pivotally coupled to each other at respective attaching portions.

Each of the pair of jaw members is pivotally coupled to the upper end portion of respective intermediate member of the pair of intermediate members. The pair of jaw members is capable of grasping at least a portion of a workpiece of the plurality of workpieces therebetween. The spring member is mounted between the pair of handle members. The spring member is capable of being compressed and retracted based on a pivotal movement of the pair of handle members. The locking mechanism is configured on the pair of handle members. The locking mechanism is adapted to enable the pair of handle members to attain one of a locked state and an unlocked state. Accordingly, upon applying a grasping force to the pair of handle members, the spring member is compressed and the pair of intermediate members converge towards each other, thereby allowing the pair of jaw members to grasp the at least a portion of the workpiece therebetween for assembling and disassembling the plurality of workpieces. Further, upon grasping the at least a portion of the workpiece, the pair of handle members are held in the locked state by the locking mechanism. Moreover, upon attaining the unlocked state of the locking mechanism and releasing the grasping force from the pair of handle members, the spring member is retracted and the pair of intermediate members separate from each other, thereby allowing the pair of jaw members to release the grasp from the at least a portion of the workpiece.

This together with the other aspects of the present disclosure, along with the various features of novelty that characterize the present disclosure, is pointed out with particularity in the claims annexed hereto and forms a part of the present disclosure. For a better understanding of the present disclosure, its operating advantages, and the specified object attained by its uses, reference should be made to the accompanying drawing and descriptive matter in which there are illustrated exemplary embodiments of the present disclosure.

### BRIEF DESCRIPTION OF THE DRAWINGS

The advantages and features of the present disclosure will become better understood with reference to the following detailed description and claims taken in conjunction with the accompanying drawings, and in which:

FIG. 1 illustrates an exploded perspective view of a hand tool for assembling and disassembling a plurality of work pieces, in accordance with an embodiment of the present disclosure;

FIG. 2A illustrates a perspective view of the hand tool of FIG. 1 in a locked state, in accordance with an embodiment of the present disclosure;

FIG. 2B illustrates a front view of the hand tool of FIGS. 1 and 2A in an unlocked state, in accordance with an embodiment of the present disclosure;

FIG. 3 illustrates a partial left hand side view of the hand tool of FIG. 2B, in accordance with an embodiment of the present disclosure;

FIG. 4 illustrates an exemplary environment showing the hand tool of FIGS. 1, 2A, and 2B gripping a plurality of workpieces together in the locked state thereof for assembling the plurality of workpieces, in accordance with an embodiment of the present disclosure; and

FIG. 5 illustrates an exemplary environment showing utilization of the hand tool of FIGS. 1, 2A, and 2B in a confined space, in accordance with an embodiment of the present disclosure.

Like reference numerals refer to like parts throughout the description of several views of the drawings.

### DETAILED DESCRIPTION OF THE DISCLOSURE

The exemplary embodiments described herein detail for illustrative purposes are subject to many variations in structure and design. It should be emphasized, however, that the present disclosure is not limited to a hand tool for assembling and disassembling a plurality of workpieces, as shown and described. It is understood that various omissions and substitutions of equivalents are contemplated as circumstances may suggest or render expedient, but these are intended to cover the application or implementation without departing from the spirit or scope of the claims of the present disclosure. Also, it is to be understood that the phraseology and terminology used herein is for the purpose of description and should not be regarded as limiting.

The terms “first,” “second,” and the like, herein do not denote any order, quantity, or importance, but rather are used to distinguish one element from another, and the terms “a” and “an” herein do not denote a limitation of quantity, but rather denote the presence of at least one of the referenced item.

The present disclosure provides a hand tool for assembling and disassembling a plurality of workpieces. More specifically, the hand tool may be used for assembling and disassembling the plurality of workpieces, such duct pieces, used in a duct system. For example, the hand tool is capable of being used for assembling a plurality duct pieces together to form a long duct that may be used for transporting air, heat, and the like, from one area to another area in a commercial or residential building structure. The hand tool of the present disclosure is capable of being used by the single hand of an individual while the individual is assembling and disassembling the plurality of workpieces. Further, the hand tool is capable of gripping workpieces together without a support of the individual's hand. Moreover, the hand tool of the present disclosure is capable of being used in a confined space for assembling and disassembling workpieces.

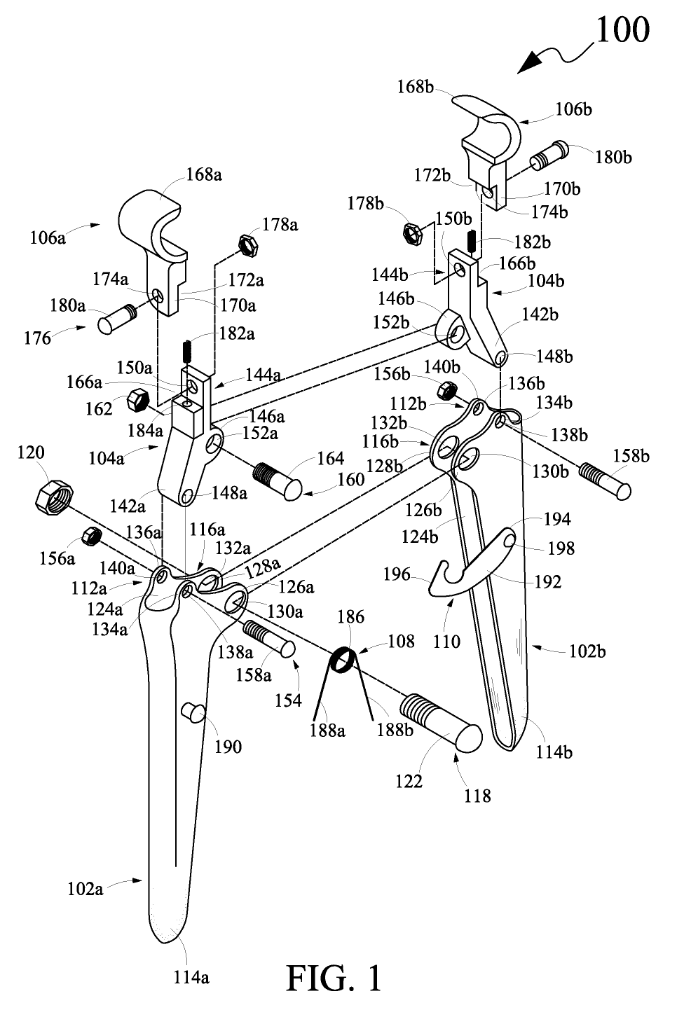

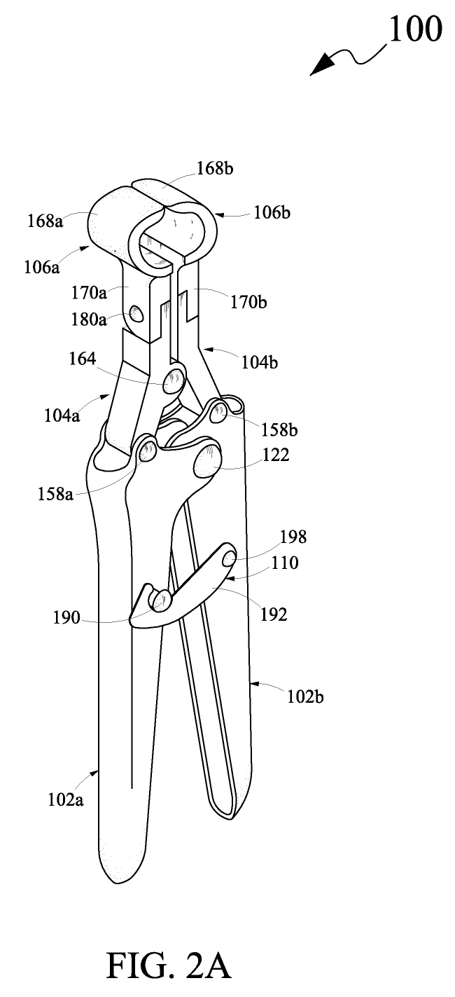

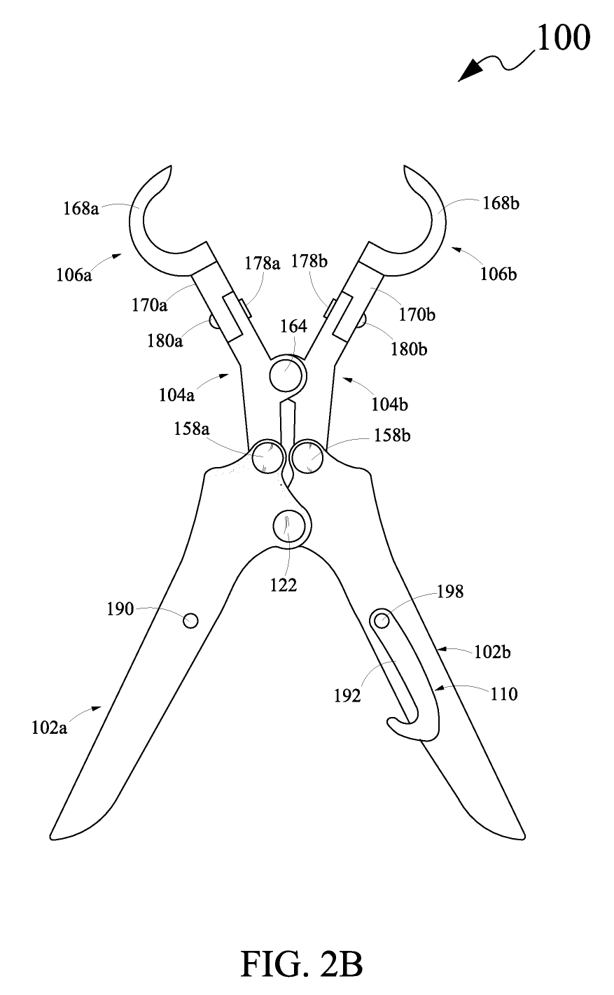

Referring to FIGS. 1, 2A, and 2B, various views of a hand tool 100 for assembling and disassembling a plurality of work pieces are illustrated, in accordance with the embodiments of the present disclosure. More specifically, FIG. 1 illustrates an exploded perspective view of the hand tool 100, FIG. 2A illustrates a perspective view of the hand tool 100 in a locked state, and FIG. 2B illustrate a front view of the hand tool 100 in an unlocked state.

As shown in FIG. 1, the hand tool 100 includes a pair of handle members, such as a first handle member 102a and a second handle member 102b (hereinafter collectively referred to as a pair of handle members 102a, 102b), a pair of intermediate members, such as a first intermediate member 104a and a second intermediate member 104b (hereinafter collectively referred to as a pair of intermediate members 104a,104b) coupled to the pair of handle members 102a, 102b, a pair of jaw members, such as a first jaw member 106a and a second jaw member 106b (hereinafter collectively referred to as a pair of jaw members 106a, 106b) coupled to the pair of intermediate members 104a, 104b, a spring member 108 mounted between the pair of handle members 102a, 102b, and a locking mechanism 110 configured on the pair of handle members 102a, 102b.

The each handle member of the pair of handle members 102a, 102b includes a top end portion, a bottom end portion, and coupling portion extending sideways from the top end portion. More specifically, the first handle member 102a includes a top end portion 112a, a bottom end portion 114a, and a coupling portion 116a extending sideways from the top end portion 112a. Similarly, the second handle member 102b includes a top end portion 112b, a bottom end portion 114b, and a coupling portion 116b extending sideways from the top end portion 112b. The pair of handle members 102a, 102b is pivotally coupled to each other at respective coupling portions 116a and 116b.

In one embodiment of the present disclosure, the pair of handle members 102a, 102b is pivotally coupled to each other at the respective coupling portions 116a and 116b by a first nut and bolt arrangement 118. The first nut and bolt arrangement 118 includes a first nut 120 and a first bolt 122 capable of being threadably coupled to the first nut 120. More specifically, the first bolt 122 of the first nut and bolt arrangement 118 is capable of being received by the coupling portions 116a and 116b and thereafter threadably coupled to the first nut 120 for enabling the pivotal coupling of the pair of handle members 102a, 102b. The pivotal coupling of the pair of handle members 102a, 102b is explained later with reference to FIG. 1. Further, it will be evident to those skilled in the art that the pair of handle members 102a, 102b may be pivotally coupled to each other by any suitable fastening mechanism other than the first nut and bolt arrangement 118, such as a rivet arrangement.

As shown in FIG. 1, each of the pair of handle members 102a, 102b includes a channel running along a length thereof. For example, the first handle member 102a includes a channel 124a and the second handle member 102b includes a channel 124b running along the lengths thereof. Therefore, each of the coupling portions 116a and 116b of the pair of handle members 102a, 102b, respectively, includes a pair of coupling flanges parallely spaced apart. For example, the coupling portion 116a includes a pair of coupling flanges 126a and 128a parallely spaced apart. Further, each of the pair of coupling flanges 126a and 128a includes a first through hole configured thereon. Specifically, the pair of coupling flanges 126a and 128a includes first through holes 130a and 132a, respectively configured thereon. Similarly, the coupling portion 116b of the second handle member 102b includes a pair of coupling flanges 126b and 128b parallely spaced apart. Moreover, the pair of coupling flanges 126b and 128b includes first through holes 130b and 132b, respectively configured thereon.

In the present embodiment, a distance between the pair of coupling flanges 126b and 128b is smaller as compare to a distance between the pair of coupling flanges 126a and 128a. Accordingly, the pair of coupling flanges 126b and 128b is capable of being received within the pair of coupling flanges 126a and 128a. Further, the first through holes 130a and 132a of the pair of coupling flanges 126a and 128a, respectively, and the first through holes 130b and 132b of the pair of coupling flanges 126b and 128b, respectively, are aligned for receiving the first bolt 122 therethrough. Thereafter, the first nut 120 is threadably coupled to the first bolt 122 for facilitating the pivotal coupling between the pair of handle members 102a, 102b.

The pair of handle members 102a, 102b is further pivotally coupled to the pair of intermediate members 104a, 104b. More specifically, the top end portions 112a and 112b of the first handle member 102a and the second handle member 102b, respectively, are pivotally coupled to the pair of intermediate members 104a, 104b. In the present embodiment, each of the top end portions 112a and 112b includes a pair of top coupling flanges parallely spaced apart. More specifically, the top end portion 112a of the first handle member 102a includes a pair of top coupling flanges 134a and 136a parallely spaced apart from each other. Further, the pair of top coupling flanges 134a and 136a include second through holes 138a and 140a, respectively configured thereon. Similarly, the top end portions 112b of the second handle member 102b includes a pair of top coupling flanges 134b and 136b parallely spaced apart. Moreover, the pair of top coupling flanges 134b and 136b include second through holes 138b and 140b respectively configured thereon.

As shown in FIG. 1, each of the pair of intermediate members 104a, 104b includes a lower end portion, an upper end portion, and an attaching portion extending between the upper end portion and the lower end portion. More specifically, the first intermediate member 104a includes a lower end portion 142a, an upper end portion 144a, and an attaching portion 146a extending between the upper end portion 144a and the lower end portion 142a. Similarly, the second intermediate member 104b includes a lower end portion 142b, an upper end portion 144b, and an attaching portion 146b extending between the upper end portion 144b and the lower end portion 142b. Further, each of the lower end portion, the upper end portion, and the attaching portion of the pair of intermediate members 104a, 104b includes a through hole configured thereon. For example, the lower end portion 142a, the upper end portion 144a, and the attaching portion 146a of the first intermediate member 104a include through holes 148a, 150a, and 152a, respectively configured thereon. Similarly, the lower end portion 142b, the upper end portion 144b, and the attaching portion 146b of the second intermediate member 104b include through holes 148b, 150b and 152b, respectively configured thereon.

The lower end portions 142a and 142b of the pair of intermediate members 104a, 104b, respectively, are pivotally coupled to the top end portions 112a and 112b, respectively, of the pair of handle members 102a, 102b. In the present embodiment, the pair of handle members 102a, 102b is pivotally coupled to the pair of intermediate members 104a, 104b, respectively, by a second nut and bolt arrangement 154. The second nut and bolt arrangement 154 includes a pair of second nuts 156a and 156b and a pair second bolts 158a and 158b.

Further, the lower end portions 142a and 142b of the pair of intermediate members 104a, 104b, respectively, are received between the pair of top coupling flanges 134a and 136a, and the pair of top coupling flanges 134b and 136b, respectively. Furthermore, the second through holes 138a and 140a of the pair of top coupling flanges 134a and 136a, respectively, are aligned with the through hole 148a of the lower end portion 142a of the first intermediate member 104a. Similarly, the second through holes 138b and 140b of the pair of top coupling flanges 134b and 136b, respectively, are aligned with the through hole 148b of the lower end portion 142b of the second intermediate member 104b. Moreover, the pair of second bolts 158a and 158b are received through the aligned holes and thereafter threadably coupled to the pair of second nuts 156a and 156b, respectively, for facilitating the pivotal coupling between the pair of intermediate members 104a, 104b and the pair of handle members 102a, 102b. For example, the second bolt 158a is received through the second through holes 138a and 140a, and the through hole 148a and thereafter threadably coupled to the second nut 156a for facilitating the pivotal coupling of the first intermediate member 104a with the first handle member 102a. Similarly, the second bolt 158b is received through the second through holes 138b and 140b, and the through hole 148b and thereafter threadably coupled to the second nut 156b for enabling the pivotal coupling of the second intermediate member 104b with the second handle member 102b.

The pair of intermediate members 104a, 104b is further pivotally coupled to each other at respective attaching portions 146a and 146b. The attaching portion 146a is extending between the upper end portion 144a and the lower end portion 142a of the first intermediate member 104a, and the attaching portion 146b is extending between the upper end portion 144b and the lower end portion 142b of the second intermediate member 104b. Further, as shown in FIG. 1, thickness of the attaching portion 146a is about half thickness of the first intermediate member 104a, and similarly thickness of the attaching portion 146b is about half thickness of the second intermediate member 104b. Accordingly, due the half thickness of the attaching portions 146a and 146b enable in receiving the attaching portions 146a and 146b over each other such that the through hole 152a configured on the attaching portion 146a aligns with the through hole 152b configured on the attaching portion 146b. Therefore, the attaching portions 146a and 146b may be coupled to each other by a third nut and bolt arrangement 160 for facilitating the pivotal coupling between the pair of intermediate members 104a, 104b.

In the present embodiment, the third nut and bolt arrangement 160 includes a third nut 162 and a third bolt 164. The third bolt 164 is capable of being received through the aligned through holes 152a and 152b of the attaching portions 146a and 146b, respectively, and thereafter the third nut 162 is threadably coupled to the third bolt 164 for facilitating the pivotal coupling between the pair of intermediate members 104a, 104b at the respective attaching portions 146a and 146b.

The pair of intermediate members 104a, 104b is further pivotally coupled to the pair of jaw members 106a, 106b, respectively. More specifically, the pair of jaw members 106a, 106b is pivotally coupled to the upper end portions 144a and 144b of respective intermediate member of the pair of intermediate members 104a, 104b. As shown FIG. 1, each of the upper end portions 144a and 144b of the pair of intermediate members 104a, 104b includes a cutout portion. For example, the upper end portion 144a of the first intermediate member 104a includes a cutout portion 166a configured thereon and the upper end portion 144b of the second intermediate member 104b includes a cutout portion 166b configured thereon.

The cutout portions 166a and 166b of the upper end portions 144a and 144b, respectively, are capable of receiving the pair of jaw members 106a, 106b thereon. As shown in FIG. 1, each of the pair of jaw members 106a, 106b includes a gripping portion and a neck portion extending from the gripping portion. More specifically, the first jaw member 106a includes a gripping portion 168a and a neck portion 170a extending from the gripping portion 168a, and the second jaw member 106b includes a gripping portion 168b and a neck portion 170b extending from the gripping portion 168b.

In the present embodiment, the gripping portions 168a and 168b of the pair of jaw members 106a, 106b are configured to assume a C-shaped structure. Further, each of the neck portions 170a and 170b of the pair of jaw members 106a, 106b is configured to include a cutout portion and a through hole configured thereon. For example, the neck portion 170a of the first jaw member 106a includes a cutout portion 172a and a through hole 174a, and the neck portion 170b of the second jaw member 106b includes a cutout portion 172b and a through hole 174b. The cutout portions 172a and 172b of the neck portions 170a and 170b, respectively, are configuration-wise complementary to the cutout portions 166a and 166b, respectively.

Accordingly, the neck portions 170a and 170b of the pair of jaw members 106a, 106b, respectively, are capable of being received on the upper end portions 144a and 144b of the pair of intermediate members 104a, 104b. Further, the pair of jaw members 106a, 106b is pivotally coupled to the upper end portions 144a and 144b of respective intermediate member of the pair of intermediate members 104a, 104b by a fourth nut and bolt arrangement 176. The fourth nut and bolt arrangement 176 includes a pair of fourth nuts 178a and 178b, and a pair of fourth bolts 180a and 180b. The pair of fourth bolts 180a and 180b is capable of being received through the through holes configured on the neck portions 170a and 170b, and the upper end portions 144a and 144b. Thereafter, the pair of fourth bolts 180a and 180b is threadably coupled to the pair of fourth nuts 178a and 178b, respectively, for pivotally coupling the pair of intermediate members 104a, 104b, and the pair of jaw members 106a, 106b.

For example, upon aligning the through holes 174a and 150a configured on the neck portion 170a and the upper end portion 144a, respectively, the fourth bolt 180a is received through the through holes 174a and 150a. Thereafter, the fourth bolt 180a is threadably coupled to the fourth nut 178a for pivotally coupling the first intermediate member 104a with the first jaw member 106a. Similarly, upon aligning the through holes 174b and 150b configured on the neck portion 170b and the upper end portion 144b, respectively, the fourth bolt 180b is received through the through holes 174b and 150b. Thereafter, the fourth bolt 180b is threadably coupled to the fourth nut 178b for pivotally coupling the second intermediate member 104b with the second jaw member 106b.

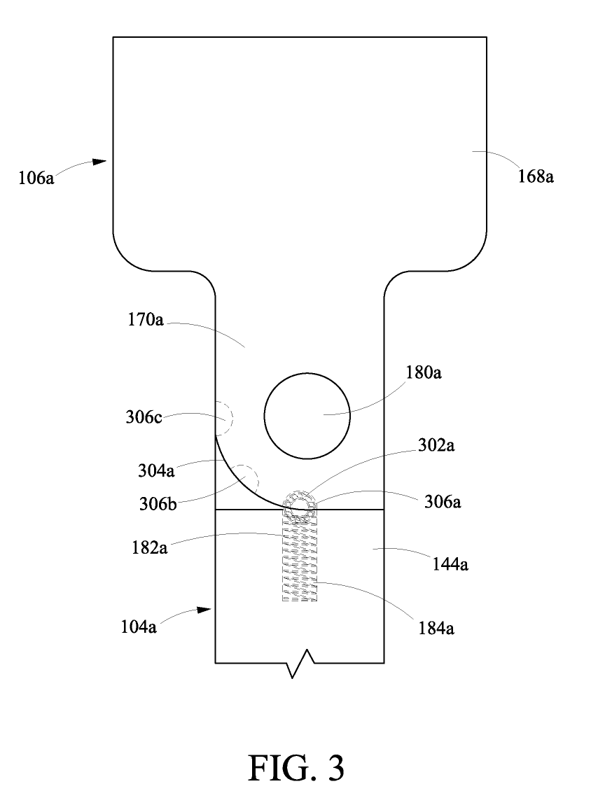

As shown in FIG. 1, the hand tool 100 further includes a pair of retainer springs 182a and 182b mounted on the respective upper end portions 144a and 144b of each of the pair of intermediate members 104a, 104b. More specifically, the retainer spring 182a is received in a slot 184a configured on the upper end portion 144a of the first intermediate member 104a. Similarly, the retainer spring 182b is received in a slot (not shown) configured on the upper end portion 144b of the second intermediate member 104b. The pair of retainer springs 182a and 182a facilitate retaining of the pair of jaw members 106a, 106a at one or more predetermined angles (hereinafter referred to as the predetermined angles) with respect to the pair of intermediate members 104a, 104b, which is further explained in conjunction with FIG. 3.

Referring to FIG. 3, a partial left hand side view of the hand tool 100 of FIG. 2B is illustrated, in accordance with an embodiment of the present disclosure. Specifically, FIG. 3 illustrates the jaw member 106a being retained by the intermediate member 104a of the hand tool 100. The hand tool 100 includes a roller bearing 302a disposed on the retainer spring 182a. Further, the retainer spring 182a is received within the slot 184a configured on the upper end portion 144a of the first intermediate member 104a. It will be obvious to a person skilled in the art that the roller bearing 302a, the retainer spring 182a, and the slot 184a will be hidden upon the hand tool 100 being viewed from a side portion thereof, and accordingly, the roller bearing 302a, the retainer spring 182a and the slot 184a are shown by using hidden lines.

As shown in FIG. 3, the neck portion 178a of the jaw member 106a further includes a curved portion 304a. The curved portion 304a enables the jaw member 106a to pivotally move about the intermediate member 104a. More specifically, the curved portion 304a of the jaw member 106a provides a clearance between the jaw member 106a and the intermediate member 104a which allows the neck portion 170a of the jaw member 104a to move pivotally about the intermediate member 104a. For example, as shown in FIG. 3, the curved portion 304a is configured on a left side of the neck portion 170a of the jaw member 104a, and accordingly the jaw member 104a may be pivotally moved in an anticlockwise direction about the fourth bolt 180a.

The curved portion 304a of the jaw member 106a includes a plurality of indentations, such as indentations 306a, 306b, and 306c configured thereon. In the present embodiment, the plurality of indentations 306a, 306b, and 306c are semi-circular cutouts, inwardly configured on the curved portion 304a. Accordingly, it will be evident to a person skilled in the art that the plurality of indentations 306a, 306b, and 306c are hidden when viewed in the side view of the hand tool 100 and, accordingly the plurality of indentations 306a, 306b, and 306c is shown by using hidden lines. The plurality of indentations 306a, 306b, and 306c is capable of partially receiving the roller bearing 302a therein. For example, the roller bearing 302a is partially received in the indentation 306a, as shown in FIG. 3.

In the present embodiment, the retainer spring 182a is received in the slot 184a in a compressed state thereof. The compressed retainer spring 182a pushes the roller bearing 302a in the indentation 306a. Further, the roller bearing 302a enables the jaw member 106a to be maintained at the predetermined angles with respect to the intermediate member 104a. More specifically, when the neck portion 170a of the jaw member 106a is pivotally moved, the roller bearing 302a enables the curved portion 304a to slide over the upper end portion 144a of the intermediate member 104a for allowing the roller bearing 302a to be received in one of the indentations 306b and 306c. Accordingly, when the roller bearing 302a is received in one the indentations 306b and 306c, the jaw member 106a may be retained at an angle, such as 45 degrees or 90 degrees, respectively, with respect to the intermediate member 104a. Otherwise, when the roller bearing 302a is received in the indentation 306a, the jaw member 106a is retained parallel to the intermediate member 104a. Furthermore, it will be evident to person skilled in the art that based on a number of indentations configured on the curved portion 304a; the jaw member 106a may be retained at various predetermined angles with respect to the intermediate member 104a.

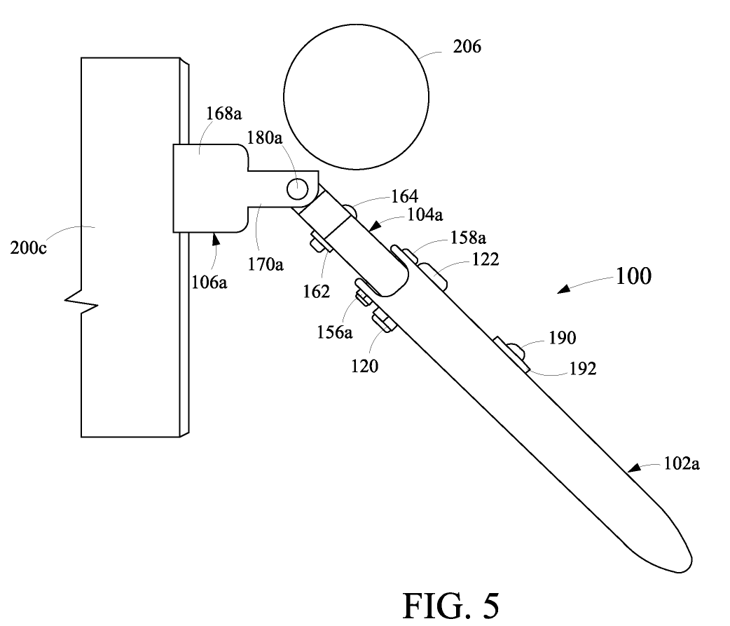

Further, it will be evident to person skilled in the art that the hand tool 100 may include a roller bearing (not shown) disposed on the retainer spring 182b similar to the roller bearing 302a disposed on the retainer spring 182a, and a plurality of indentations (not shown) configured on the neck portion 170b of the jaw member 106b similar to the plurality of indentations 306a, 306b, and 306c configured on the neck portion 170a of the jaw member 106a. The roller bearing disposed on the retainer spring 182b and the plurality of indentations configured the neck portion 170b allows the jaw member 106b to be retained at the predetermined angles with respect to the intermediate member 104b. Accordingly, the pair of jaw members 106a, 106b may be retained at the predetermined angles with respect to the intermediate members 104a, 104b for allowing the hand tool 100 to be used in a confined space for assembling and disassembling the workpieces, which is further explained in conjunction with FIG. 5. Furthermore, it will be evident to person skilled in the art that the descriptions of the roller bearing disposed on the retainer spring 182b, and the plurality of indentations configured the neck portion 170b are avoided herein for the sake of brevity.

Referring back to FIG. 1, as explained herein, the spring member 108 is mounted between the pair of handle members 102a, 102b. More specifically, the spring member 108 is mounted on the first bolt 122 for pivotally coupling the coupling portions 116a and 116b of the pair of handle members 102a, 102b, respectively. The spring member 108 includes a coil portion 186 and a pair of spring wire portions 188a and 188b extending from the coil portion 186 in opposite direction to each other. The coil portion 186 of the spring member 108 is adapted to be mounted on the first bolt 122 in a manner such that the spring wire portion 188a is received in the channel 124a of the first handle members 102a and the spring wire portion 188b is received in the channel 124b of the second handle member 102b.

Further, the spring wire portion 188a touches a portion of an inner surface (not shown) of the first handle members 102a and the spring wire portion 188b touches a portion of an inner surface (not shown) of the second handle member 102b. Accordingly, the pair of spring wire portions 188a and 188b of the spring member 108 is capable of being compressed and retracted based on a pivotal movement of the pair of handle members 102a, 102b. More specifically, when the pair of handle members 102a, 102b are converged close to each other, the spring member 108, particularly the pair of spring wire portions 188a and 188b, is compressed and when the pair of handle members 102a, 102b are separated from each other, the spring member 108, particularly the pair of spring wire portions 188a and 188b, is retracted.

In the present embodiment, when the pair of handle members 102a, 102b is converged towards each other by applying a gripping force on the pair of handle members 102a, 102b the locking mechanism 110 is adapted to enable the pair of handle members 102a, 102b to attain a locked state, as shown and explained later in conjunction with FIG. 2A. Also, the locking mechanism 110 is adapted to enable the pair of handle members 102a, 102b to attain an unlocked state, as shown and explained later in conjunction with FIG. 2B.

Referring back to FIG. 1, the locking mechanism 110 includes a knob 190 configured on the first handle member 102a and a locking member 192 configured on the second handle member 102b. The locking member 192 includes a first end portion 194 rotatably coupled to a portion (not numbered) of the second handle member 102b, and a second end portion 196 adapted to be hooked on the knob 190 for allowing the locking mechanism 110 to attain the locked state. In the present embodiment, the rotatable coupling of the first end portion 194 with the portion of the second handle member 102b is enabled by a bolt member 198. However, it will be evident to a person skilled in the art that such rotatable coupling may be facilitated by any other mechanism known in the art without departing from the scope of the present disclosure.

Accordingly, upon applying a grasping force to the pair of handle members 102a, 102b, due to the pivotal coupling therebetween, the pair of handle members 102a, 102b converges towards each other. Thereafter, the locking member 192 is moved about the bolt member 198 in a manner such that the second end portion 196 of the locking member 192 is hooked on the knob 190, thereby allowing the locking mechanism 110 to lock the pair of handle members 102a, 102b to attain the locked state. Further, upon removing the hooked second end portion 196 from the knob 190 the pair of handle members 102a, 102b may separate from each other. Specifically, due the retraction of the spring member 108 the pair of handle members 102a, 102b may separate from each other for attaining the unlocked state.

In the locked state and the unlocked state of the pair of handle member 102a, 102b the pair of jaw members 106a, 106b is allowed to attain a closed position and an open position, respectively. More specifically, as shown in FIG. 2A, in the locked state of the pair of handle members 102a, 102b the pair of jaw members 106a, 106b is allowed to attain the closed position. Further, as shown in FIG. 2B, in the unlocked state of the pair of handle members 102a, 102b the pair of jaw members 106a, 106b is allowed to attain the open position. Accordingly, the hand tool 100 of the present disclosure is capable of being used for assembling and disassembling the plurality of workpieces with the pair of jaw members 106a, 106b in the closed position and the open position thereof.

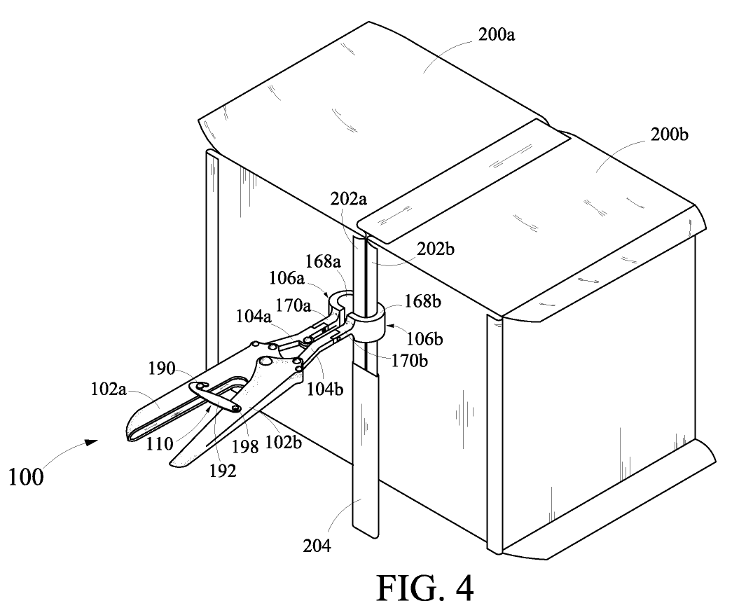

In use, the pair of jaw members 106a, 106b is capable of grasping at least a portion of a workpiece of the plurality of workpieces therebetween. Specifically, upon applying the grasping force to the pair of handle members 102a, 102b the spring member 108 is compressed and the bottom end portions 114a and 114b of the pair of handle members 102a, 102b converge towards each other. Accordingly, the top end portions 112a and 112b of each of the pair of handle members 102a, 102b separate from each other. Due to said separation of the pair of handle members 102a, 102b from each other, the lower end portions 142a and 142b that are pivotally coupled to the top end portions 112a and 112b of the pair of intermediate members 104a, 104b also separate from each other. The separated lower end portions 142a and 142b of the pair of intermediate members 104a, 104b allow the upper end portions 144a and 144b of the pair of intermediate members 104a, 104b to converge towards each other. Accordingly, the pair of jaw members 106a, 106b coupled to the upper end portions 144a and 144b, attains the closed position for grasping the at least a portion of the workpiece therebetween, as shown in FIG. 4. Further, upon grasping the at least a portion of the workpiece, the pair of handle members 102a, 102b are held in the locked state by the locking mechanism 110. In an embodiment of the present disclosure, the at least a portion of the work pieces may be a drive edge.

Furthermore, when the grasping force is removed from the pair of handle members 102a, 102b the spring member 108 is retracted and the bottom end portions 114a and 114b of the pair of handle members 102a, 102b separates from each other. Therefore, the top end portions 112a and 112b of the pair of handle members 102a, 102b, respectively move towards each other. Moreover, the lower end portions 142a and 142b, pivotally coupled to the top end portions 112a and 112b of the pair of handle members 102a, 102b, respectively, of the pair of intermediate members 104a, 104b also converge towards each other. Accordingly, the upper end portions 144a and 144b of the pair of handle members 102a, 102b, respectively, separates from each other, as shown in FIG. 2B. Therefore, the pair of jaw members 106a, 106b, coupled to the upper end portions 144a and 144b of the pair of handle members 102a, 102b, respectively, attains the open position for releasing the grasped portion of the workpiece from therebetween.

Such movement, particularly, attaining the open position of the pair of jaw members 106a, 106b by way of retraction of the spring member 108 enables the hand tool 100 to be used by single hand of an individual. More specifically, the hand tool 100 avoids a necessity of using both hands of the individual for separates the pair of handle members 102a, 102b from each other for allowing the pair of jaw members 106a, 106b to attain the open position. Accordingly, while assembling or disassembling the plurality of workpieces, the hand tool 100 may used with the single hand of the individual with the repeated opening of the pair of jaw members 106a, 106b due to the retraction of the spring member 108.

Referring now to FIG. 4, an environment for utilizing the hand tool 100 for assembling a plurality of workpieces, such as a workpiece 200a and a workpiece 200b together in the locked state thereof is illustrated, in accordance with an embodiment of the present disclosure. In the present embodiment, the hand tool 100 is shown and explained to be used for assembling and disassembling the workpieces 200a and 200b, such as duct pieces. However, it will be evident to those skilled in the art that the hand tool 100 may be used for performing other tasks such as, pulling fence wires, cutting wires, pulling nails and the like.

Generally, the workpieces 200a and 200b, such as duct pieces, are assembled to form a long duct for use in a duct system. Typically, the workpieces 200a and 200b are fabricated in a sheet metal shop by a method which is known in the art. For example, while fabricating a workpiece, such as the workpiece 200a, two pieces of sheets (not shown) are assembled along the edges thereof. Further, fabrication of the workpieces 200a and 200b is done with the help of a Pittsburgh edge and a one-fourth of an inch edge, each configured on the two pieces of sheets. The Pittsburgh edge comprises a groove capable of receiving the one-fourth of an inch edge therein. Further, the Pittsburgh edge provides a tab of about one-fourth of an inch extending above the one-fourth of an inch edge. A hammer may be used to bend the tab provided by the Pittsburgh edge for coupling the Pittsburgh edge and the one-fourth of an inch edge with each other, thereby securing the two pieces of sheets for the fabrication of the workpiece, such as the workpiece 200a.

As shown in FIG. 4, the workpieces 200a and 200b may be placed adjacent to each other with the hand tool 100 may grip a portion 202a of the workpiece 200a, and a portion 202b of the workpiece 200b together. More specifically, the hand tool 100 may grip the portion 202a, such as a drive edge (180 degree curled), of the workpiece 200a and the portion 202b, such as a drive edge (180 degree curled), of the workpiece 200b together. Further, as shown in FIG. 4, the portion 202a of the workpiece 200a and the portion 202b of the workpiece 200b are coupled to each other with the help of a drive cleat 204. The drive cleat 204 includes a channel (not shown) capable of receiving the portions 202a and 202b therein. Accordingly, the drive cleat 204 facilitates coupling of the workpiece 200a and the workpiece 200b upon covering an entire length of the portions 202a and 202b, such as the drive edges of the workpieces 200a and 200b.

For movement of the drive cleat 204 along the entire length of the portions 202a and 202b, the drive cleat 204 may be hammered. In such instance, as shown in FIG. 4, the hand tool 100 is gripping the portions 202a and 202b of the workpieces 200a and 200b together, thereby allowing the individual for performing the hammering task. More specifically, the pair of handle members 102a, 102b of the hand tool 100 is allowed to attain the locked state with the help of the locking mechanism 110, thereby allowing the pair of jaw members 106a, 106b to fixedly grip the portions 202a and 202b of the workpieces 200a and 200b therebetween. Accordingly, the hand tool 100 avoids the use of individual's hand for supporting the hand tool 100 while gripping the workpieces 200a and 200b together, thereby allowing the individual's hand for performing the hammering task. Therefore, the hand tool 100 of the present disclosure facilitates assembling the workpieces 200a and 200b, such as the duct pieces, in an effortless and speedy manner.

Further, for the purpose of maintenance or case of any error, the assembled workpieces, such as the workpieces 200a and 200b, may be disassembled from each other with the help of the hand tool 100. Furthermore, the edges, such as the Pittsburgh edge and the one-fourth of an inch edge, may be opened with the help of the pair of jaw members 106a, 106b of the hand tool 100. In an advantageous embodiment of the present disclosure, the hand tool 100 may be utilized in a confined space for assembling and disassembling the workpieces, as explained in conjunction with FIG. 5.

Referring to FIG. 5, an environment for utilizing the hand tool 100 in a confined space is illustrated, in accordance with an embodiment of the present disclosure. More specifically, the hand tool 100 may grip a workpiece, such as a workpiece 200c, positioned adjacent to a structure, such as a pipe or wall. For example, as shown in FIG. 5, the workpiece 200c is positioned closed to a structure, such as a pipe 206, and accordingly a space therebetween may be a confined space for operating the hand tool 100 therein. However, the hand tool 100 disclosed herein is capable of being used in the confined space for assembling and disassembling workpieces.

As explained herein, the pair of jaw members 106a, 106b is pivotally coupled to the pair of intermediate members 104a, 104b. For example, the neck portion 170a of the first jaw member 106a is pivotally coupled to the upper end portion 144a of the first intermediate member 104a by the fourth bolt 180a, and the neck portion 170b of the second jaw member 106b is pivotally coupled to the upper end portion 144b of the second intermediate member 104b by the fourth bolt 180b, as shown in FIG. Accordingly, the pair of jaw members 106a, 106b may be pivotally moved or bent with respect to the pair of intermediate members 104a, 104b for being accommodated in the confined space between the workpiece 200c and the pipe 206 in a manner as shown in FIG. 5. Further, the pair of jaw members 106a, 106b may be retained at the predetermined angles, such as 45 degrees and 90 degrees, with respect to the pair of intermediate member 106a and 106b with the help of roller bearings, such as the roller bearing 302a, as explained in conjunction with FIG. 3. Accordingly, the hand tool 100 of the present disclosure is capable of being utilized in the confined spaced for assembling and disassembling the workpieces, such as duct pieces, due to the pivotal movement of the pair of jaw members 106a, 106b.

In an exemplary embodiment illustrated in FIG. 5, the pair of jaw members 106a, 106b is shown to be aligned at about 45 degrees with respect to the pair of intermediate members 104a, 104b for being accommodated in the confined space, as explained in conjunction with FIG. 3. However, the pair of jaw members 106a, 106b of the hand tool 100 is capable of being pivotally moved up to 90 degrees for being accommodated in a confined space. Moreover, after the use of the hand tool 100 in the limited space, the pair of jaw members 106a, 106b may be pivotally moved to align themselves with the pair of intermediate members 104a, 104b.

The hand tool, such as the hand tool 100, provides a convenient and a speedy way for assembling and disassembling workpieces, such as duct pieces. More specifically, the hand tool is capable of being used with one hand by an individual for assembling and disassembling workpieces. Further, the hand tool is capable of gripping workpieces together without a support of an individual's hand. Furthermore, the hand tool is capable of being used in a constrained space for assembling and disassembling workpieces. Moreover, the hand tool of the present disclosure may be used for performing other tasks apart from assembling and disassembling workpieces, such as pulling fence wires, cutting wires, pulling nails and the like.

The foregoing descriptions of specific embodiments of the present disclosure have been presented for purposes of illustration and description. They are not intended to be exhaustive or to limit the present disclosure to the precise forms disclosed, and obviously many modifications and variations are possible in light of the above teaching. The embodiments were chosen and described in order to best explain the principles of the present disclosure and its practical application, to thereby enable others skilled in the art to best utilize the present disclosure and various embodiments with various modifications as are suited to the particular use contemplated. It is understood that various omission and substitutions of equivalents are contemplated as circumstance may suggest or render expedient, but such are intended to cover the application or implementation without departing from the spirit or scope of the claims of the present disclosure.

What is claimed is:

1. A hand tool for assembling and disassembling a plurality of workpieces, the hand tool comprising:
a pair of handle members, each handle member of the pair of handle members comprising a top end portion, a bottom end portion, and a coupling portion extending sideways from the top end portion, the pair of handle members pivotally coupled to each other at respective coupling portions;
a pair of intermediate members, each intermediate member of the pair of intermediate members comprising a lower end portion, an upper end portion, and an attaching portion extending between the upper end portion and the lower end portion, the lower end portion of each of the pair of intermediate members pivotally coupled to the top end portion of respective handle member of the pair of handle members, wherein the pair of intermediate members is pivotally coupled to each other at respective attaching portions;
a pair of jaw members, each of the pair of jaw members pivotally coupled to the upper end portion of respective intermediate member of the pair of intermediate members, the pair of jaw members capable of grasping at least a portion of a workpiece of the plurality of workpieces therebetween;
a spring member mounted between the pair of handle members, the spring member capable of being compressed and retracted based on a pivotal movement of the pair of handle members; and
a locking mechanism configured on the pair of handle members, the locking mechanism adapted to enable the pair of handle members to attain one of a locked state and an unlocked state,
wherein upon applying a grasping force to the pair of handle members, the spring member is compressed and the pair of intermediate members converge towards each other thereby allowing the pair of jaw members to grasp the at least a portion of the workpiece therebetween for assembling and disassembling the plurality of workpieces, and
wherein upon grasping the at least a portion of the workpiece, the pair of handle members are held in the locked state by the locking mechanism.

2. The hand tool of claim 1, wherein upon attaining the unlocked state of the locking mechanism and releasing the grasping force from the pair of handle members, the spring member is retracted and the pair of intermediate members separates from each other thereby allowing the pair of jaw members to release the grasp from the at least a portion of the workpiece.

3. The hand tool of claim 1, wherein the coupling portion of each of the pair of handle members is pivotally coupled to each other by a first nut and bolt arrangement.

4. The hand tool of claim 1, wherein the top end portion of each of the pair of handle members is pivotally coupled to the lower end portion of respective intermediate member of the pair of intermediate members by a second nut and bolt arrangement.

5. The hand tool of claim 1, wherein the attaching portion of each of the pair of intermediate portions is pivotally coupled to each other by a third nut and bolt arrangement.

6. The hand tool of claim 1, wherein each of the pair of jaw members is pivotally coupled to the upper end portion of respective intermediate member of the pair of intermediate members by a fourth nut and bolt arrangement.

7. The hand tool of claim 1, wherein the locking mechanism comprises
a knob configured on a first handle member of the pair of handle members, and
a locking member configured on a second handle member of the pair of handle members, the locking member having a first end portion rotatably coupled to a portion of the second handle member, and a second end portion adapted to be hooked on the knob for allowing the locking mechanism to attain the locked state.

8. The hand tool of claim 1, further comprising a pair of retainer springs and a pair of roller bearings disposed on the pair of retainer springs, each of the pair of roller bearings being mounted between a jaw member of the pair of jaw members and the respective upper end portion of each of the pair of intermediate members, wherein the pair of retainer springs and the pair of roller bearings are adapted to retain the pair of jaw members at one or more predetermined angles with respect to the pair of intermediate members.

9. The hand tool of claim 8, wherein the upper end portion of each of the pair of intermediate members comprises a slot configured therein for receiving a retainer spring of the pair of retainer springs.

10. The hand tool of claim 8, wherein each of the pair of jaw members comprises a plurality of indentations, the plurality of indentations being capable of partially receiving a roller bearing of the pair of roller bearings to retain the pair of jaw members at the one or more predetermined angles with respect to the pair of intermediate members.

11. The hand tool of claim 1, wherein the plurality of workpieces comprises a plurality of duct pieces.
